(19) United States
(12) Patent Application Publication
(10) Pub. No.: US 2015/0081682 A1
(43) Pub. Date: Mar. 19, 2015

(54) Method and System for Filtering Search Results

(71) Applicants: Josef Frydl, Westminster, MD (US); Ivana Frydl, Westminster, MD (US); Kathleen Frydl, Washington, DC (US)

(72) Inventors: Josef Frydl, Westminster, MD (US); Ivana Frydl, Westminster, MD (US); Kathleen Frydl, Washington, DC (US)

(21) Appl. No.: 14/196,763

(22) Filed: Mar. 4, 2014

Related U.S. Application Data
(60) Provisional application No. 61/960,221, filed on Sep. 13, 2013.

(51) Int. Cl. G06F 17/30

(52) U.S. Cl. CPC G06F 17/3053
USPC 707/723

(57) ABSTRACT

A method of filtering the results of a search of an electronic database includes receiving a plurality of keyword fragments and at least one specified relationship applicable to the plurality of keyword fragments, such as proximity between the keyword fragments. The keyword fragments are used to retrieve a group of potentially responsive records from the electronic database. The keyword fragments and the relationships between and among them are also used to script a parsing expression, which is applied to the group of potentially responsive records to identify those that best match the user's query. The parsed results can be output as a rank-ordered subset of the group of potentially responsive records.

### CROSS-REFERENCE TO RELATED APPLICATIONS

This application claims the benefit of U.S. provisional application No. 61/960,221, filed 13 Sep. 2013, which is hereby incorporated by reference as though fully set forth herein.

### BACKGROUND

The instant disclosure relates to collections of electronic data. In particular, the instant disclosure relates to methods and systems to search collections of electronic data and to filter and present the results of such filtered searches.

Electronic data is growing exponentially, with recent estimates of the amount of total digital information in the world exceeding a zettabyte. A considerable amount of this information exists on the World Wide Web (the “web”). Thus, locating desired electronic information, such as on the web, can pose various challenges.

One method of searching the web is to use a human-maintained index or search engine. Although useful, these indices are often subjective and are difficult to maintain given the ever-growing amount of digital information. As a result, they can be incomplete in their coverage of the information on the web.

Another method of searching the web is to use an automated search engine, such as Google, Yahoo!, Bing, or the like. Such search engines match search terms entered by a user to a pre-indexed corpus of web pages. Refinements to such engines, such as the ability to locate semantic units within a search query as disclosed in U.S. Pat. No. 8,321,410, can enhance the ability of a user to find information of value, but they do not offer any filtering of the results. They may also present results in an order that is not useful to the user.

The creation of machine-readable metadata, known as the “semantic web,” is an attempt to rectify the shortcomings of human-maintained and automated search engines. This effort, however, requires web content creators to upload and code their content as semantically structured units, essentially creating a database of information that can be searched using these semantically structured units. This effort is both time consuming and incomplete—much of the content on the web remains unstructured, leaving the semantic web limited in reach.

Another method for locating information on the web in a more focused and systematic fashion is web data extraction, also known as web “scraping.” This technique collects unstructured data on the web, typically by using automated tools that recognize the underlying data structure of a web page. These tools, however, require special software and training, such that only a limited number of users make use of them.

### BRIEF SUMMARY

Disclosed herein is a method of filtering the results of searching an electronic database including: establishing a user interface; receiving, through the user interface, a plurality of keyword fragments; executing a search of the electronic database using the plurality of keyword fragments, wherein the search of the electronic database outputs a group of search results; constructing a parsing expression from the keyword fragments; parsing the group of search results using the parsing expression to generate a ranked set of search results; and presenting the ranked set of search results via the user interface. The keyword fragments can include a first keyword fragment and a second keyword fragment, and a relationship between the first and second keyword fragments can also be specified. It is also contemplated that the keyword fragments can be organized into groups, with relationships also specified between groups of keyword fragments.

It is contemplated that the teachings herein can be applied to good advantage where the electronic database is an unstructured electronic database, such as the World Wide Web or a lexical database.

In certain embodiments, the step of constructing a parsing expression from the keyword fragments includes: inputting the keyword fragments to a natural language processing compiler; and outputting the parsing expression from the natural language processing compiler. The natural language processing compiler can use definite clause grammar to script the parsing expression.

According to an aspect disclosed herein, parsing the group of search results using the parsing expression can include using a parsing engine to parse the group of search results. The parsing engine can use PROLOG or any other parsing language.

Parsing the group of search results using the parsing expression can include: parsing each search result within the group of search results using the parsing expression; assigning a score to each search result within the group of search results according to a level of correspondence between the parsing expression and the search result; and rank-ordering the group of search results by score. It is contemplated that, in embodiments, the ranked group of search results excludes any search result with a score of zero.

Each step of the method can be performed by a server.

Also disclosed herein is a method of filtering the results of a search of an electronic database, including: receiving a plurality of keyword fragments from a user; receiving at least one specified relationship applicable to the plurality of keyword fragments from the user; using the plurality of keyword fragments to retrieve a group of potentially responsive records from the electronic database; creating a parsing expression from the plurality of keyword fragments and the at least one specified relationship; parsing the group of potentially responsive records using the parsing expression; and outputting a subset of the group of potentially responsive records, wherein the subset is rank-ordered according to correspondence to the parsing expression.

According to one aspect, the parsing expression is created by: inputting the plurality of keyword fragments and the at least one specified relationship to a natural language processing compiler; and outputting the parsing expression from the natural language processing compiler. Further, the group of potentially responsive records can be parsed by: inputting a record from the group of potentially responsive records into a parsing engine; parsing the record from the group of potentially responsive records using the parsing expression; and assigning a score to the record from the group of potentially responsive records according to correspondence between the record and the parsing expression. This can be repeated for each record in the group of potentially responsive records.

According to yet another aspect disclosed herein, a system for filtering the results of a search of an electronic database includes: a user interface processor that generates a user interface and that receives, via the user interface, a plurality of keyword fragments and at least one specified relationship applicable to the plurality of keyword fragments; a search processor that executes a search of the electronic database using the plurality of keyword fragments and that returns a group of search results; a parsing expression generation processor that generates a parsing expression using the plurality of keyword fragments and the at least one specified relationship applicable to the plurality of keyword fragments; and a parsing engine processor that parses the group of search results using the parsing expression and that outputs, via the user interface, a subset of the group of search results, wherein the subset comprises search results that include at least one match to the parsing expression. The subset of the group of search results can be rank-ordered according to a number of matches between a search result and the parsing expression. The parsing expression generator can use definite clause grammar to generate the parsing expression, and the parsing engine processor can use PROLOG, or another parsing language, to parse the group of search results.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 depicts a representative computing environment.

FIG. 2 is a flowchart of representative steps that can be carried out to execute a search and filter the results according to an embodiment of the teachings herein.

FIG. 3 illustrates a user interface according to an embodiment of the teachings herein.

FIG. 4 illustrates the output of a search according to an embodiment of the teachings herein.

### DETAILED DESCRIPTION

The present disclosure provides methods and systems for searching an electronic database and for filtering the search results. As used herein, the term “database” includes not only structured data sets, but also unstructured and/or free form data sets. For purposes of illustration, several exemplary embodiments will be described in detail herein in the context of searching the World Wide Web. It should be understood, however, that the methods and systems described herein can be utilized in other contexts (e.g., searching the unstructured electronic archives of a particular publication or embedded in a web application format).

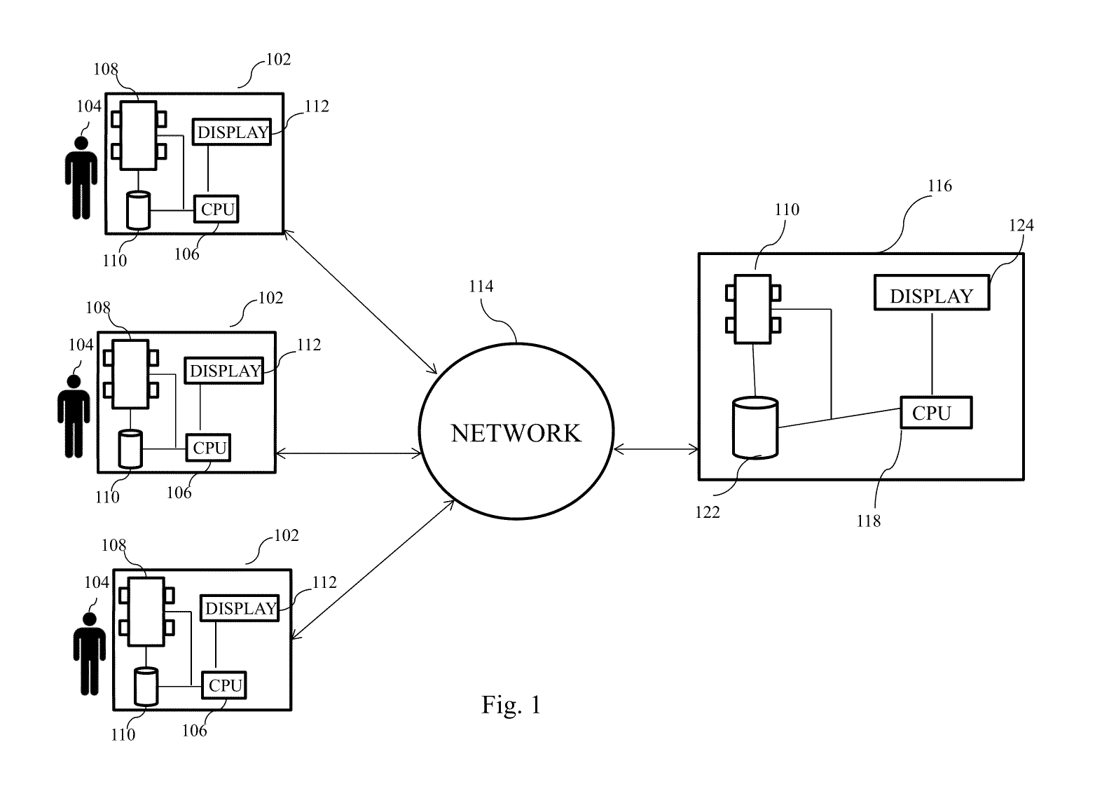

FIG. 1 depicts a representative computing environment 100 in which the teachings herein can be practiced. Environment 100 includes a plurality of client computing devices 102, each belonging to and/or used by a corresponding user 104.

Client computing devices 102 can be any computing device including, without limitation, general purpose computers, special purpose computers, distributed computers, desktop computers, laptop computers, tablet computers, smartphones, personal digital assistants, e-readers, and the like. In general, client computing devices 102 include a processor 106, memory 108 (e.g., random access memory (“RAM”)), storage 110 (e.g., a hard drive), and a display 112. As used herein, the term processor refers to not only a single central processing unit (“CPU”), but also to a plurality of processing units, commonly referred to as a parallel processing environment.

Client computing devices 112 can include additional devices, such as various input devices (e.g., keyboards, track pads, touchscreens) and output devices (e.g., speakers, printers). For the sake of clarity of illustration, however, these additional devices are not depicted in FIG. 1.

Client computing devices 102 are coupled to a network 114, such as the Internet. Thus, client computing devices 102 and/or users 104 can communicate with each other over network 114. The ordinarily skilled artisan will be familiar with numerous ways to connect client computing device 102 to network 114, including via wire (e.g., Ethernet) or via a wireless connection (e.g., 802.11, Bluetooth). Amongst other capabilities, client computing devices 102 include a browser, such as Microsoft's Internet Explorer browser, Apple's Safari browser, Mozilla's Firefox browser, Google's Chrome browser, or the like, that can be used to access network 114 (e.g., the Internet).

A server device 116 is also coupled to network 114, thus allowing client computing devices 102 to communicate with server device 116. Similar to client computing devices 102, server device 116 can include a processor 118, memory 120, storage 122, and a display 124. Of course, server device 116 can also include additional devices, which are not depicted in the interest of clarity of illustration. Moreover, although server device 116 is depicted as a single machine including a single CPU, it is contemplated that server device 116 can be a distributed computing environment including multiple physical and/or virtual devices including multiple CPUs, multiple cores, and/or multiple threads.

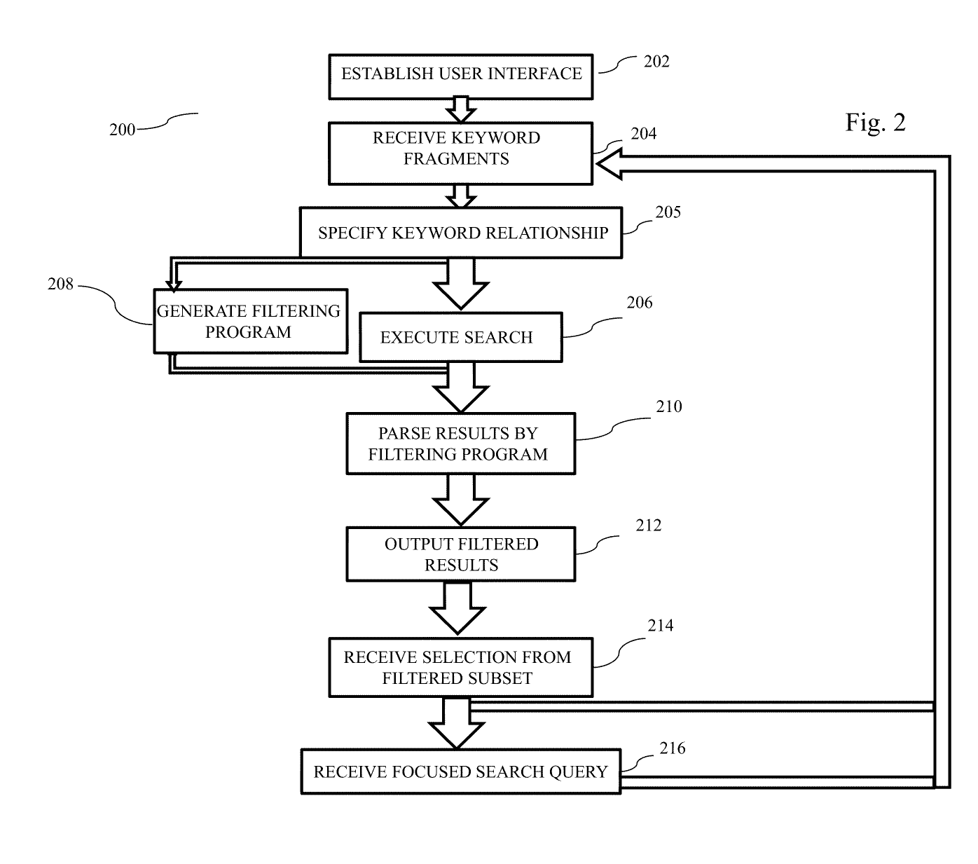

FIG. 2 is a flowchart 200 of representative steps that can be carried out to search an electronic database, such as the World Wide Web. In some embodiments, flowchart 200 may represent several exemplary steps that can be carried out by server device 116 (e.g., by one or more processors 118). It should be understood that the representative steps described below can be either hardware- or software-implemented.

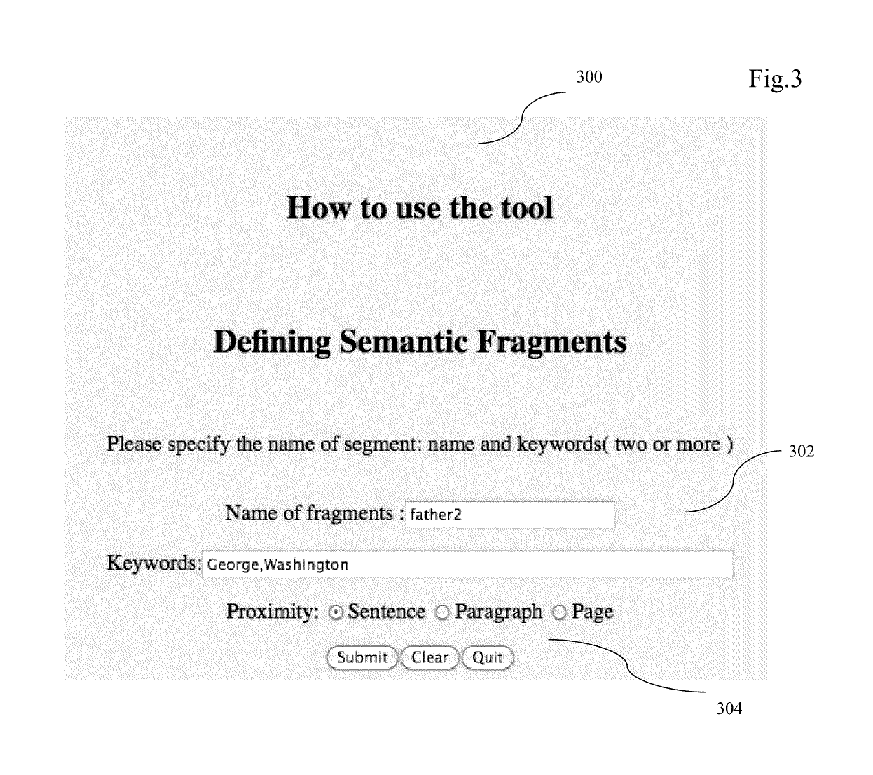

In block 202, a user interface is established. This user interface can be established, for example, by server device 116 executing computer-readable program instructions (e.g., via a user interface processor) stored in memory 120 and/or storage 122. The interface can be established on display 112 of client computing device 102, such as in response to a request from client computing device 102 that takes the form of user 104 using the browser of client computing device 102 to visit a particular uniform resource locator (“URL”) for server device 116, and, more particularly, for the search functions of server device 116 as described herein. FIG. 3 depicts a user interface 300 as implemented in an exemplary method and system according to the teachings herein.

In block 204, user 104 enters a plurality of keyword fragments into user interface 300 and submits the search query to server device 116 (e.g., to the user interface processor). The keyword fragments can be entered, for example in text field 302 of user interface 300. As used herein, the term “keyword fragment” includes any alphanumeric string, and thus encompasses, without limitation, words, numbers, symbols, initials, and the like. The term “keyword fragment” also includes placeholders for a concept word, such as hyponyms and hypernyms of a particular term. Thus, for example, the search query “1600 Pennsylvania Avenue” includes three keyword fragments (“1600,” “Pennsylvania,” and “Avenue”), while the search query “major league baseball performance enhancing drugs” includes six (“major,” “league,” “baseball,” “performance,” “enhancing,” and “drugs”).

The user can also specify one or more relationships applicable to the keyword fragments in block 205. For example, in the case of a query using four famous Americans—Thomas Jefferson, Benjamin Franklin, George Washington, and Alexander Hamilton—the user can further specify that the keyword fragments “George” and “Washington” must have a certain proximity to each other (e.g., adjacent, within a certain number of characters, within a certain number of words, within the same sentence, within the same paragraph, on the same page, etc.). This can be accomplished, for example, by selecting the appropriate proximity radio button 304.

The user can also specify relationships for the other keyword fragments (e.g., “Benjamin” and “Franklin,” “Thomas” and “Jefferson,” and “Alexander” and “Hamilton”), and can also assign a label or name to the keyword fragments and their relationship (e.g., “father2,” as shown in FIG. 3). Finally, the user can specify a relationship between groups of keyword fragments, such as by specifying that the keyword fragment groups “Thomas Jefferson,” “Benjamin Franklin,” “George Washington,” and “Alexander Hamilton” must occur in the same paragraph.

In block 206, the keyword fragments are used (e.g., by a search processor within server device 116) to execute a search of the electronic database. This search can be conducted using any suitable search engine, including, without limitation, Google, Yahoo!, and Bing, in the case of the World Wide Web. The search of the electronic database returns a group of search results—that is, a group of records from within the electronic database that are potentially responsive to the keyword fragments.

It should be appreciated, however, that the group of search results can be over-inclusive. In many cases, the group of search results will include significant noise—results that contain numerous “hits” to the keyword fragments but that are not what the user is looking for. The user can sometimes reduce the noise by enclosing a set of keyword fragments in quotation marks, which causes the search engine to search for the entire phrase as entered instead of only the keyword fragments individually. This, however, can lead to an under-inclusive group of search results by excluding documents that would be of interest to the user but that do not contain the entered phrase precisely.

The methods and systems disclosed herein address these shortcomings in extant search engines by using machine understanding to ascertain the meaning of the query received from the user and seeking this meaning in the group of search results. Thus, in block 208, server device 116 (e.g., via a parsing expression generation processor) generates a filtering program, including both a parsing expression and a program to apply the parsing expression to a group of search results, using the keyword fragments and their relationships as provided by the user. Blocks 206 and 208 can occur either in series (in any order) or in parallel.

In certain embodiments, the parsing expression is generated by inputting the search keyword fragments and their respective relationships to a natural language processing compiler. The natural language processing compiler then uses this input to generate and output the parsing expression, such as by using definite clause grammar to script the parsing expression.

For example, returning to the “Founding Fathers” example discussed above, a representative parsing expression would be:
<(“Benjamin”,guarded_ostr(“Franklin”,33),“Franklin”)
(“Thomas”,guarded_ostr(“Jefferson”,33),“Jefferson”)
(“George”,guarded_ostr(“Washington”,33),“Washington”)
(“Alexander”,guarded_ostr(“Hamilton”,33),“Hamilton”)>
   wherein the instruction “guarded_ostr” instructs continued parsing, but stop if the first argument (e.g.,“Benjamin”) or the second argument (e.g., “Franklin”) consumed 33 characters and did not find the first argument, where 33 characters is selected because the specified relationship (e.g., proximity) is within the same sentence. Thus, the ordinarily skilled artisan will appreciate that this parameter can be larger or smaller depending on the user-specified relationship between keyword fragments.

In block 210, server device 116 (e.g., via a parsing engine processor) uses the filtering program generated in block 208 to parse the search results output from block 206. The parsing engine can use any parsing language, such as PROLOG, to parse the search results.

As each search result is parsed, it is assigned a score according to how well the search result corresponds to the filtering program's parsing expression. For example, a search result can be assigned one point for each match to the parsing expression. Because the parsing expression is itself an effort to ascertain the meaning of the original query, therefore, the results are, in effect, scored according to the degree to which they express or contain the meaning of the query.

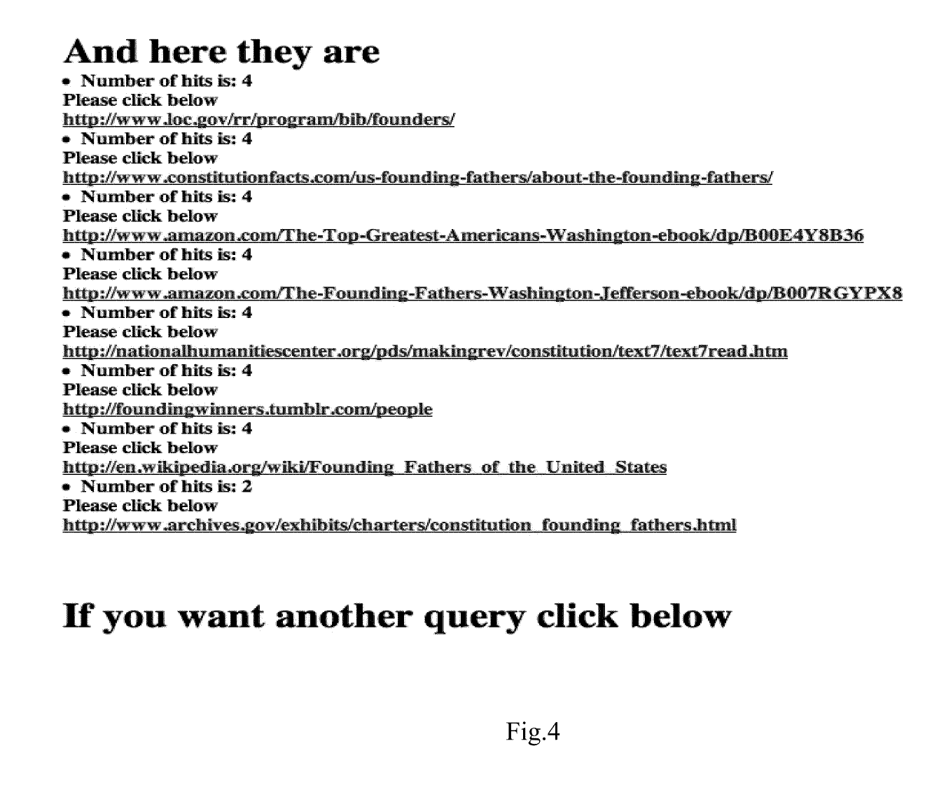

In block 212, the parsing engine of block 210 outputs a subset of the search results returned by the search engine of block 206. The results of block 212 can be output on display 112 of client computing device 102 via user interface 300, for example as shown in FIG. 4.

The results of block 212 are filtered, in that they will include only those results that include at least one match to the parsing expression. That is, the subset of results output by the parsing engine of block 210 excludes results that do not bear any relation to the parsing expression, and thus are most unlikely to be relevant to the original query. This helps alleviate the problems of over- and under-inclusive search engine results.

The results of block 212 can also be rank-ordered according to their score, such that the search results that are most likely to be relevant to the original query appear first. This presentation offers advantages over the order of result presentation by extant search engines, which use factors such as link structure, frequency of visit, or even payments to the search engine provider to determine the order of results.

In other words, the methods and systems disclosed herein select the search results that have the strongest bearing upon and/or relation to a user's interest as ascertained from the user's original query. The search results are not limited to the semantic web, and the user is not required to understand how to perform web scraping or how to structure anything more than a basic query containing keyword fragments. Thus, the user is able to perform a rigorous search of the World Wide Web, or any other structured or unstructured collection of electronic data, without undertaking the burden of sifting through unwanted information or running the risk of constructing a search that is so narrow that it excludes valuable, responsive information.

Although several embodiments of this invention have been described above with a certain degree of particularity, those skilled in the art could make numerous alterations to the disclosed embodiments without departing from the spirit or scope of this invention.

For example, in block 214, the user can select a result from the filtered subset of results in block 212 that most closely matches what the user was initially looking for. A new filtering program, including a new, refined parsing expression, can be generated from this selected result in a loop back to blocks 206 and 208, and this new filtering program can be used to re-execute the searching and filtering (e.g., steps 206, 208, and 210) and output a new set of filtered results in block 212. Alternatively, instead of selecting from among the original filtered subset of results, the user could enter a new search query in block 216.

As another example, although only a single server device 116 is discussed above, it is contemplated that multiple physical and/or virtual server devices 116, including multiple processors, can be employed. This has the advantage of allowing for parallel parsing of multiple search results, increasing the speed with which filtered results are delivered in block 212.

As another example, the teachings herein can be implemented on client computing devices 102 instead of, or in addition to, on server device 116.

As still another example, the teachings herein can be embedded in a web application, for use in that context or any other to perform predictive, automated searching and filtering.

As yet another example, the teachings herein can be used in conjunction with large lexical databases, such as WordNet, a lexical database for English.

All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A method of filtering results from a search of an electronic database, comprising:
establishing a user interface;
receiving, through the user interface, a plurality of keyword fragments;
executing a search of the electronic database using the plurality of keyword fragments, wherein the search of the electronic database outputs a group of search results;
constructing a parsing expression from the plurality of keyword fragments;
parsing the group of search results using the parsing expression to generate a ranked set of search results; and
presenting the ranked set of search results via the user interface.

2. The method according to claim 1, wherein the plurality of keyword fragments comprises:
a first keyword; and
a second keyword fragment; and
further comprising receiving, through the user interface, a specified relationship between the first keyword fragment and the second keyword fragment.

3. The method according to claim 1, wherein the plurality of keyword fragments comprises:
a first grouping of keyword fragments; and
a second grouping of keyword fragments; and
further comprising receiving, through the user interface, a specified relationship between the first grouping of keyword fragments and the second grouping of keyword fragments.

4. The method according to claim 1, wherein the electronic database comprises an unstructured electronic database.

5. The method according to claim 4, wherein the electronic database comprises the World Wide Web.

6. The method according to claim 4, wherein the electronic database comprises a lexical database.

7. The method according to claim 1, wherein constructing a parsing expression from the plurality of keyword fragments comprises:
inputting the plurality of keyword fragments to a natural language processing compiler; and
outputting the parsing expression from the natural language processing compiler.

8. The method according to claim 7, wherein the natural language processing compiler uses definite clause grammar to script the parsing expression.

9. The method according to claim 1, wherein parsing the group of search results using the parsing expression comprises using a parsing engine to parse the group of search results.

10. The method according to claim 9, wherein the parsing engine comprises PROLOG.

11. The method according to claim 1, wherein parsing the group of search results using the parsing expression further comprises:
parsing each search result within the group of search results using the parsing expression;
assigning a score to each search result within the group of search results according to a level of correspondence between the parsing expression and the search result; and
rank-ordering the group of search results by score.

12. The method according to claim 11, wherein the ranked group of search results excludes any search result with a score of zero.

13. The method according to claim 1, wherein each step is performed by a server.

14. A method of filtering results from a search of an electronic database, comprising:
receiving a plurality of keyword fragments and at least one specified relationship applicable to the plurality of keyword fragments from a user;
using the plurality of keyword fragments to retrieve a group of potentially responsive records from the electronic database;
creating a parsing expression from the plurality of keyword fragments and the at least one specified relationship;
parsing the group of potentially responsive records using the parsing expression; and
outputting a subset of the group of potentially responsive records, wherein the subset is rank-ordered according to correspondence to the parsing expression.

15. The method according to claim 14, wherein creating a parsing expression from the plurality of keyword fragments and the at least one specified relationship comprises:
inputting the plurality of keyword fragments and the at least one specified relationship to a natural language processing compiler; and
outputting the parsing expression from the natural language processing compiler.

16. The method according to claim 14, wherein parsing the group of potentially responsive records using the parsing expression comprises:
inputting a record from the group of potentially responsive records into a parsing engine;
parsing the record from the group of potentially responsive records using the parsing expression; and
assigning a score to the record from the group of potentially responsive records according to correspondence between the record and the parsing expression.

17. The method according to claim 16, further comprising repeating:
inputting the record from the group of potentially responsive records into the parsing engine;
parsing the record from the group of potentially responsive records using the parsing expression; and
assigning a score to the record from the group of potentially responsive records according to correspondence between the record and the parsing expression, for each record in the group of potentially responsive records.

18. The method according to claim 14, further comprising:
receiving a user selection of a record within the subset of the group of potentially responsive records;
creating a refined parsing expression using the user-selected record; and
parsing the subset of the group of potentially responsive records using the refined parsing expression.

19. A system for filtering results of a search of an electronic database, comprising:
a user interface processor that generates a user interface and that receives, via the user interface, a plurality of keyword fragments and at least one specified relationship applicable to the plurality of keyword fragments;
a search processor that executes a search of the electronic database using the plurality of keyword fragments and that returns a group of search results;
a parsing expression generation processor that generates a parsing expression using the plurality of keyword fragments and the at least one specified relationship applicable to the plurality of keyword fragments; and
a parsing engine processor that parses the group of search results using the parsing expression and that outputs, via the user interface, a subset of the group of search results, wherein the subset comprises search results that include at least one match to the parsing expression.

20. The system according to claim 19, wherein the subset of the group of search results is rank-ordered according to a number of matches between a search result and the parsing expression.
